(19) United States
(12) Patent Application Publication
(10) Pub. No.: US 2022/0018570 A1
(43) Pub. Date: Jan. 20, 2022

(54) System And A Method For Optimized Regulation Of An Arrangement Of A Plurality of Fans

(71) Applicant: ebm-papst Mulfingen GmbH & Co. KG, Mulfingen (DE)

(72) Inventors: Daniel Conrad, Langenbrettach (DE); Erik REICHERT, Boxberg (DE)

(21) Appl. No.: 17/376,552

(22) Filed: Jul. 15, 2021

(30) Foreign Application Priority Data
Jul. 15, 2020 (DE) 10 2020 118 725.4

(51) Int. Cl. F24F 11/77; F24F 11/62; F24F 11/46

(52) U.S. Cl. CPC F24F 11/77; F24F 2110/30; F24F 11/46; F24F 11/62

(57) ABSTRACT

A method and an air treatment system with a fan arrangement having kₘₐₓ fans. The respective speed nᵢ of the fans is regulatable. A control and regulation system regulates the speeds nᵢ, where iϵ[1, 2, 3, 4, 5, . . . , k] of the k of kₘₐₓ fans. A certain operating point of the air treatment system is set with a specific overall power Pₜₒₜₐₗ of the air treatment system as a function of the respective set speeds nᵢ. The control and regulation system has a mechanism to determine the speed combination(s) of the speeds nᵢ of the k fans where the total power Pₜₒₜₐₗ of the air treatment system is reduced or is minimal compared to other speed combinations of the speeds nᵢ.

### CROSS-REFERENCE TO RELATED APPLICATION

This application claims priority to German Patent Application No. 102020118725.4 filed Jul. 15, 2020. The entire disclosure of the above application is incorporated herein by reference.

### FIELD

The disclosure relates to a system and to a method for optimized regulation of an arrangement of a plurality of fans (fan array).

### BACKGROUND

Fans are regularly used in buildings, systems, and in clean room laboratories.

To date, the prior art has provided only inadequate systems and control methods for regulating such fan arrangements and operating them with optimal overall efficiency for a specific ventilation task.

At issue in particular is the joint operation of different kinds of fan, i.e., with different characteristics, types, and/or other fan properties that have an influence on the ventilation task.

For example, EP 1604116 B1 discloses a fan arrangement in an air treatment system with at least three fan units. The at least three fan units are arranged in the fan arrangement. A control system is provided that is able to operate the fan units substantially at maximum efficiency by strategically turning selected fan units on and off. However, this application only describes the result to be achieved, but not the technical means by which such optimum efficiency can be achieved.

The disclosure is therefore based on the object of overcoming known drawbacks of the prior art. It provides an optimized and improved system and method for controlling a fan arrangement.

### SUMMARY

This object is achieved by the combination of features including an air treatment system with a fan arrangement with kₘₐₓ fans. The respective speed nᵢ of the fans is regulatable. A control and regulation system is designed to regulate the speeds nᵢ, where iϵ[1, 2, 3, 4, 5, . . . , k] of k of the kₘₐₓ fans. Accordingly, it is possible to set a certain operating point of the air treatment system with a specific overall power Pₜₒₜₐₗ of the air treatment system as a function of the respective set speeds nᵢ. The control and regulation system also has a mechanism to determine the speed combination(s) of the speeds nᵢ of the k of kₘₐₓ fans where the total power Pₜₒₜₐₗ of the air treatment system is reduced or minimal compared to other speed combinations of the fan speeds nᵢ.

According to the disclosure, an air treatment system with a fan arrangement including kₘₐₓ fans is proposed. The respective speed nᵢ of the fans is regulatable. A control and regulation system is designed to regulate the speeds nᵢ, where iϵ[1, 2 3, 4, 5, . . . , k] of k of the kₘₐₓ fans. Thus, it is possible to set a certain operating point of the air treatment system with a specific overall power Pₜₒₜₐₗ of the air treatment system as a function of the respective set speeds nᵢ. The control and regulation system also has a mechanism to determine the speed combination(s) of the speeds nᵢ of the k fans where the total power Pₜₒₜₐₗ of the air treatment system is reduced or minimal compared to other speed combinations of the speeds nᵢ.

In an advantageous variant, the kₘₐₓ fans are connected in parallel.

According to the disclosure, a further provision is made where the k fans are fans of different power, type, and/or size. The k fans are arranged in a specific grid arrangement relative to one another in rows and/or columns and/or a matrix. In the context of the present disclosure, the term “fan array” is also used in the case of an exemplary row/column arrangement. However, the exact arrangement of the fans is irrelevant, especially since fans of different shapes and sizes can be combined into one arrangement.

Furthermore, a provision is advantageously made where the mechanism for regulating the performance-optimized speeds nᵢ of the kₘₐₓ fans comprises a characteristic map that has the operating points of the air treatment system. It also comprises a selection mechanism that selects the speeds nᵢ for the operating points in the characteristic map in order to achieve operation at the relevant operating point.

The operating point of the air treatment system is preferably defined by the pressure increase Δp to be achieved by the k fans and the total volume flow Qₜₒₜₐₗ to be achieved.

In order to optimize the system, it is necessary to know the appropriate speeds of the individual fans nᵢ, n₂, . . . , Nₖ of the k of kₘₐₓ fans where the total power of the fan arrangement or the array is minimal at a given operating point. In terms of the present disclosure, “minimal” refers to the range of the total power with a relative local minimum.

If, according to the disclosure, fans are connected in parallel, the total volume flow results from the sum of the individual volume flows of the k fans and the total power from the sum of the individual powers, as follows:

$${P}_{total} = {\sum }_{i = 1}^{k} {P}_{i} ( {n}_{i} ) and$$

$${Q}_{total} = {\sum }_{i = 1}^{k} {Q}_{i} ( {n}_{i} ) where {Q}_{i} = \frac{φ i \cdot {π}^{2} \cdot {D}_{i}^{3} \cdot {n}_{i}}{4}$$

Accordingly, part of the problem according to the disclosure is an optimization problem (optimality condition=minimization of the total power of the fan arrangement) with the secondary condition of a defined total volume flow.

The parameters used in this description are defined as follows:

kₘₐₓ Total number of fans
k Number of active fans
ψᵢ Pressure factor of the fan i, where i=1, . . . , k
ϕᵢ Flow coefficient of fan i, where i=1, . . . , k

### η Efficiency

Δpmin Minimum pressure increase
Δpmax Maximum pressure increase
Qmin Minimum volume flow
Qmax Maximum volume flow
dp Preset change in pressure
dQ Specified change in volume flow
nᵢ Speed of the fan i, where i=1, . . . , k
ni,max Maximum speed of the fan i
Pᵢ Fan power of the fan i
Pₒₚₜ Optimal fan power
Pₘₐₓ Maximum fan power

### Dᵢ Diameter of the fan i

The dimensionless power P* is given for the respective fan by:

$${P}_{i}^{*} = \frac{{ψ}_{i} \cdot {φ}_{i}}{{η}_{i}}$$

The following relationship applies to the power of the fan i:

$${P}_{i} = {P}_{i}^{*} \cdot \frac{{π}^{4} \cdot {D}_{i}^{5} \cdot {n}_{i}^{3} \cdot ρ}{8}$$

The power and the volume flow are calculated in such a way that they become pure functions of the speed. The dimensionless pressure and efficiency characteristics of the fans used are required for this. The respective dimensionless pressure characteristic is approximated with a second-order polynomial. An approximation using a quadratic approach is preferred here, since the approximation function in the considered area ϕ>0 is then strictly monotonic:

ψᵢ(φᵢ)=a_{ψ,i}·φᵢ²+c_{ψ,i}

With this mathematical description of the pressure coefficient, the flow rate can be expressed as a function of the constant coefficients of the polynomial approximation, the diameter, the density, the speed, and the pressure increase.

As a result, at a given operating point, the speed is the only variable that can be influenced by the control.

$${φ}_{i} ( {n}_{i} ) = - \frac{{b}_{ψ , i}}{2 {a}_{ψ , i}} + \sqrt{{( \frac{{b}_{ψ , i}}{2 {a}_{ψ , i}} )}^{2} - \frac{{c}_{ψ , i}}{{a}_{ψ , i}} + \frac{2 Δ p}{ρ \cdot {π}^{2} \cdot {D}_{i}^{2} \cdot {n}_{i}^{2} \cdot {a}_{ψ , i}}}$$

One then obtains the following equation for the partial derivative of the flow rate according to speed:

$$\frac{\partial {φ}_{i}}{\partial {n}_{i}} = - \frac{\frac{2 Δ p}{ρ \cdot {π}^{2} \cdot {D}_{i}^{2} \cdot {n}_{i}^{3} \cdot {a}_{ψ , i}}}{\sqrt{{( \frac{{b}_{ψ , i}}{2 {a}_{ψ , i}} )}^{2} - \frac{{c}_{ψ , i}}{{a}_{ψ , i}} + \frac{2 Δ p}{ρ \cdot {π}^{2} \cdot {D}_{i}^{2} \cdot {n}_{i}^{2} \cdot {a}_{ψ , i}}}}$$

If we now consider the efficiency of the system, we can also approximate it using a fourth-order polynomial equation, namely as follows:

ηᵢ(φᵢ)=a_{η,i}·φᵢ⁴+b_{η,i}·φᵢ³+c_{η,i}·φᵢ²+d_{η,i}·φᵢ+e_{η,i}

a, b, c, and d stand for the coefficients in the respective order of this polynomial equation. It therefore has a maximum depending on the flow rate. This results in the following differential equation for the partial derivative of the flow rate according to speed:

$$\frac{\partial {η}_{i}}{\partial {n}_{i}} = ( 4 {a}_{η , i} \cdot {φ}_{i}^{3} + 3 {b}_{η , i} \cdot {φ}_{i}^{2} + 2 {c}_{η , i} \cdot {φ}_{i} + {d}_{η , i} ) \cdot \frac{\partial {φ}_{i}}{\partial {n}_{i}}$$

The aim is of course to optimize performance. With the aid of the partial derivative of the flow rate and the partial derivative of the efficiency according to speed, the partial derivative of the dimensionless power P* can be determined, preferably with the value for the coefficient b=0.

$$\begin{matrix}\frac{\partial {P}_{i}^{*}}{\partial {n}_{i}} = \frac{\partial ( {a}_{ψ , i} \cdot {φ}_{i}^{3} + {b}_{ψ , i} \cdot {φ}_{i}^{2} + {c}_{ψ , i} \cdot {φ}_{i} )}{\partial {η}_{i} ( {φ}_{i} )} \\ = 3 \cdot {a}_{ψ , i} {φ}_{i}^{2} \cdot {η}_{i}^{- 1} \cdot \frac{\partial {φ}_{i}}{\partial {n}_{i}} - {a}_{ψ , i} {φ}_{i}^{3} \cdot {η}_{i}^{- 2} \cdot \frac{\partial {η}_{i}}{\partial {n}_{i}} + \\ 2 \cdot {b}_{ψ , i} {φ}_{i}^{2} \cdot {η}_{i}^{- 1} \cdot \frac{\partial {φ}_{i}}{\partial {n}_{i}} - {b}_{ψ , i} {φ}_{i}^{2} \cdot {η}_{i}^{- 2} \cdot \frac{\partial {η}_{i}}{\partial {n}_{i}} + \\ {c}_{ψ , i} \cdot {η}_{i}^{- 1} \cdot \frac{\partial {φ}_{i}}{\partial {n}_{i}} - {c}_{ψ , i} {φ}_{i} \cdot {η}_{i}^{- 2} \cdot \frac{\partial {η}_{i}}{\partial {n}_{i}}\end{matrix}$$

As a result, the partial derivative of the power P and that of the volume flow Q can be determined as follows:

$$\frac{\partial {P}_{i}}{\partial {n}_{i}} = \frac{{π}^{4} \cdot {D}_{i}^{5} \cdot ρ}{8} ( 3 {n}_{i}^{3} \cdot {P}_{i}^{*} + {n}_{i}^{3} \cdot \frac{\partial {P}_{i}^{*}}{\partial {n}_{i}} )$$

$$\frac{\partial {Q}_{i}}{\partial {n}_{i}} = \frac{{π}^{2} \cdot {D}_{i}^{3}}{4} ( {φ}_{i} + {n}_{i} \cdot \frac{\partial {φ}_{i}}{\partial {n}_{i}} )$$

The relationships derived above are now used further as follows. The solution of the optimization problem results in a system of equations with k+1 unknowns (with k speeds and a Lagrange multiplier A).

$$\frac{\partial {P}_{1}}{\partial {n}_{1}} = λ \cdot \frac{\partial {Q}_{1}}{\partial {n}_{1}}$$

$$⋮$$

$$\frac{\partial {P}_{k}}{\partial {n}_{k}} = λ \cdot \frac{\partial {Q}_{k}}{\partial {n}_{k}}$$

$${Q}_{total} = {\sum }_{i = 1}^{k} {Q}_{i} ( {n}_{i} )$$

As already explained further above, the solution of the system of equations (speeds nᵢ of the fans) minimizes the required power of the fan arrangement at a given operating point Δp and Qₜₒₜₐₗ.

By varying the specified operating point and solving the system of equations again, for each operating point in a fan characteristic map with Δpₘᵢₙ Δp Δpₘₐₓ and Qₘᵢₙ≤Q≤Qₘₐₓ, the optimal speed combination of the k fans and the optimal combination of the k different fan types themselves are obtained. In purely practical terms, the variation can be achieved by varying the speeds nᵢ while taking the speed of each fan into account. Ultimately, the partial derivatives explained above represent those curves that represent the observed change in the functional variable as a function of the speed.

The disclosure thus makes a provision that an allocation matrix is stored in the system that links the operating points in the characteristic map with the optimized speeds nᵢ identified for this purpose, preferably by means of an objective, unambiguous mapping function.

As explained in general above, a provision is made according to the disclosure where the speeds identified for an operating point are determined from the solution of differential equations for either the powers Pᵢ and/or the volume flow Qᵢ and partial derivatives thereof. These have the speeds nᵢ as variable parameters.

Another aspect of the present disclosure relates to a method for setting an operating point of an air treatment system according to one of the preceding claims comprising the following steps:

a. Determining the number k of fans from among the kₘₐₓ fans;
b. Solving the following differential equations in order to determine the speeds nᵢ:

$$\frac{\partial {P}_{1}}{\partial {n}_{1}} = λ \cdot \frac{\partial {Q}_{1}}{\partial {n}_{1}}$$

$$⋮$$

$$\frac{\partial {P}_{k}}{\partial {n}_{k}} = λ \cdot \frac{\partial {Q}_{k}}{\partial {n}_{k}}$$

in consideration of a required minimum overall level of performance,

$${Q}_{total} = {\sum }_{i = 1}^{k} {Q}_{i} ( {n}_{i} )$$

where Qᵢ denotes the volume flow contribution of the fan i of the k fans to the total volume flow Qₜₒₜₐₗ.

In particular, the method can also be carried out using the following steps:

c. Selecting an operating point;
d. Selecting the speeds nᵢ of the fans from a characteristic map;
e. Regulating the speeds nᵢ of the k fans.

Further areas of applicability will become apparent from the description provided herein. The description and specific examples in this summary are intended for purposes of illustration only and are not intended to limit the scope of the present disclosure.

### DRAWINGS

Other advantageous developments of the disclosure are in the subclaims and/or depicted in greater detail below together with the description of the preferred embodiment of the disclosure with reference to the figures. In the drawing:

FIG. 1 is a schematic representation of a fan arrangement including kₘₐₓ=4, thus 4 fans.

FIG. 2 is an exemplary characteristic map relating to the size of the fan arrangement with k=4 identical fans, for example.

FIGS. 3a, 3b is a flow chart for operating a fan arrangement, broken down into FIGS. 3a and 3b.

### DETAILED DESCRIPTION

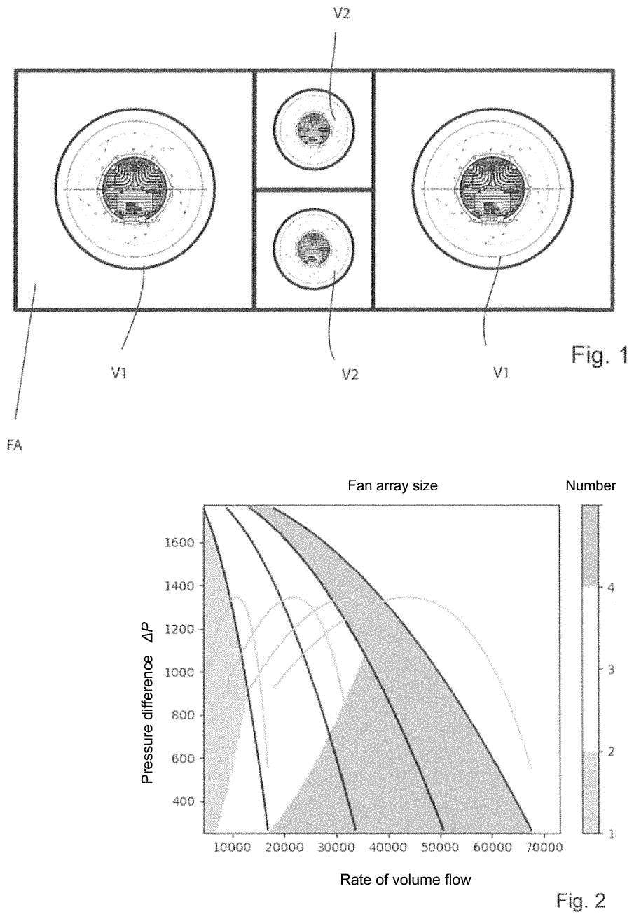

The disclosure will be described in greater detail below with reference to FIGS. 1 to 3. FIG. 1 shows a fan arrangement connected in parallel with kₘₐₓ=4 fans V. This represents a fan array FA made up of 2 different fan types V1, V2 of different power and size.

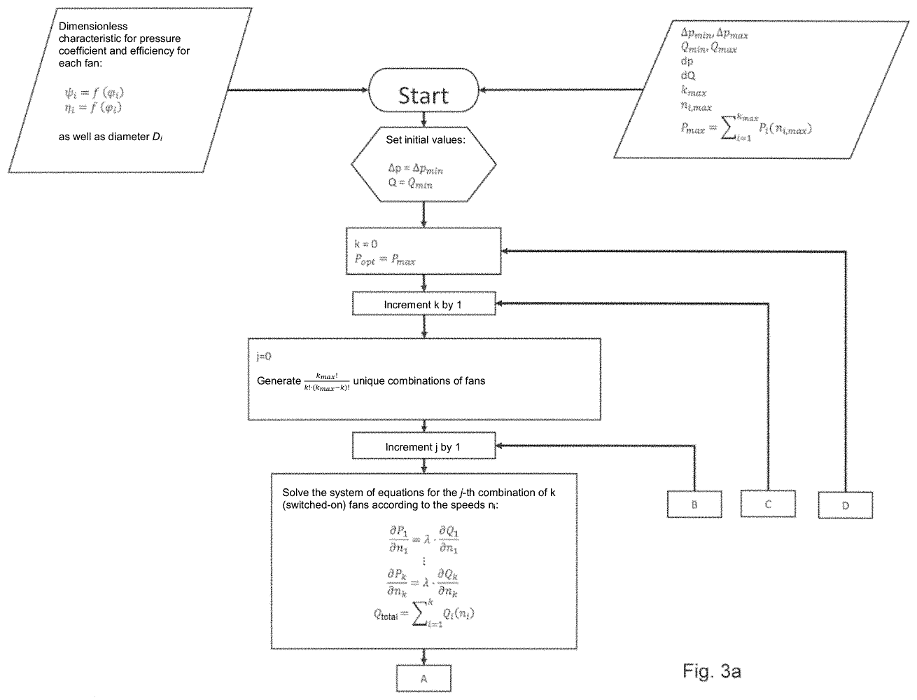

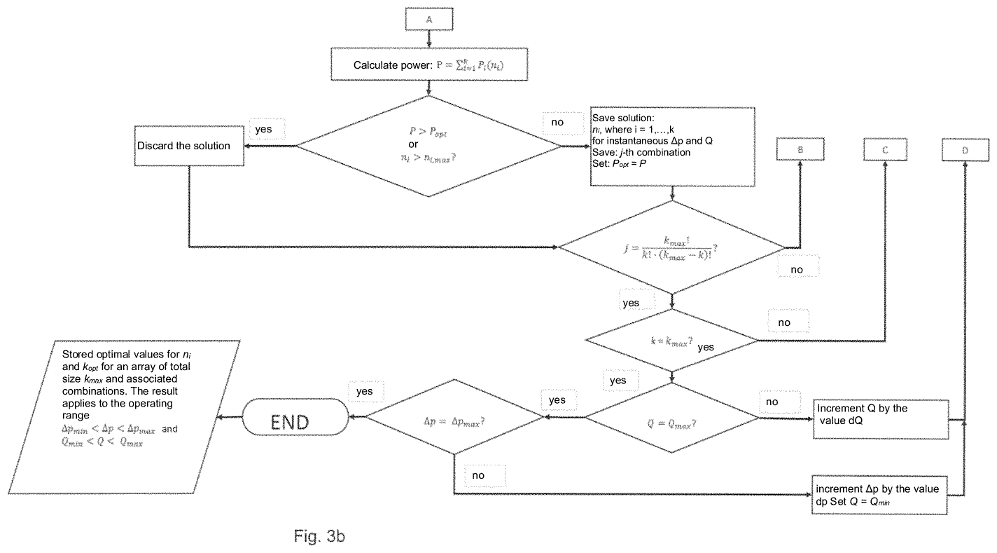

It is also advantageous if, as an alternative, assuming the optimum speeds are known, the number and/or combination of the fans from among the k fans is determined in order to operate at an optimized operating point. For example, according to FIG. 1, if the optimum speeds are known in both cases, the two large fans V1 can be switched on while the smaller fans V2 remain switched off. Alternatively, the method may identify a solution where it is more advantageous to activate the two small fans V2 together with one of the fans V1 while the second larger fan V1 remains switched off. FIG. 2 shows an exemplary characteristic map relating to the size of the fan arrangement. In the exemplary characteristic map, the optimum number of active fans is shown for each operating point. Thus, upon completion of the program flow (according to FIG. 3), the optimal fan configuration with the corresponding optimal speeds of these fans is available at each operating point.

FIGS. 3a and 3b must be viewed in tandem and show a flow chart explaining the control and regulation concept of the disclosure.

The disclosure is not limited in its execution to the abovementioned preferred exemplary embodiments. Rather, a number of variants are conceivable that make use of the illustrated solution even in the form of fundamentally different embodiments.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An air treatment system with a fan arrangement including kₘₐₓ fans, the respective speed nᵢ of the fans is regulatable, and a control and regulation system is designed to regulate the speeds nᵢ, where iϵ[1, 2, 3, 4, 5, . . . , k] of k of the kₘₐₓ fans, setting a certain operating point of the air treatment system with a specific overall power Pₜₒₜₐₗ of the air treatment system as a function of the respective set speeds nᵢ, the control and regulation system has a mechanism for determining the speed combination(s) of the speeds nᵢ of the k of kₘₐₓ fans where the total power Pₜₒₜₐₗ of the air treatment system is reduced or minimal compared to other speed combinations of the speeds nᵢ.

2. The air treatment system as set forth in claim 1, wherein the kₘₐₓ fans are connected in parallel.

3. The air treatment system as set forth in claim 1, wherein the kₘₐₓ fans are fans of different power, type, and/or size that are preferably arranged in a certain arrangement relative to one another in rows and/or columns and/or a matrix or in another arrangement relative to one another.

4. The air treatment system as set forth in claim 1, wherein the mechanism for regulating the performance-optimized speeds nᵢ of the kₘₐₓ fans comprises a characteristic map that has the operating points of the air treatment system and further comprises a selection mechanism that shows the speeds nᵢ at the operating points selected in the map in order to implement the operation at the relevant operating point

5. The air treatment system as set forth in claim 1, wherein the operating point of the air treatment system is preferably defined by the pressure increase Δp and the total volume flow Qₜₒₜₐₗ to be achieved by the k fans.

6. The air treatment system as set forth in claim 4, wherein an allocation matrix is also stored in the system as a mechanism that links the operating points in the characteristic map with the optimal combinations of fan types identified for this purpose and their respective optimal speeds nᵢ, preferably using an objective, unambiguous mapping function.

7. The air treatment system as set forth in claim 5, wherein the speeds identified for an operating point are determined from the solution of differential equations for either the powers Pᵢ or the volume flow Qᵢ and partial derivatives, these have the speeds nᵢ as variable parameters.

8. The air treatment system as set forth in claim 5, wherein the speeds nᵢ identified for an operating point are determined from the solution of the differential equations for either the powers Pᵢ and/or the volume flow Qᵢ and partial derivatives, these have the speeds nᵢ as variable parameters.

9. A method for setting an operating point of an air treatment system, preferably as in claim 1, comprising the following steps:
a. Determining the number k of fans from among the kₘₐₓ fans;
b. Solving the following differential equations in order to determine the speeds nᵢ;
$$\frac{\partial {P}_{1}}{\partial {n}_{1}} = λ \cdot \frac{\partial {Q}_{1}}{\partial {n}_{1}}$$
$$⋮$$
$$\frac{\partial {P}_{k}}{\partial {n}_{k}} = λ \cdot \frac{\partial {Q}_{k}}{\partial {n}_{k}}$$
considering a required minimum overall level of performance,
$${Q}_{total} = {\sum }_{i = 1}^{k} {Q}_{i} ( {n}_{i} )$$
where Qᵢ denotes the volume flow contribution of the fan i of the k fans to the total volume flow Qₜₒₜₐₗ.

10. The method as set forth in claim 9, further comprising the steps of:
a. Selecting an operating point;
b. Selecting the speeds nᵢ of the fans from a characteristic map;
c. Regulating the speeds nᵢ of the k fans.

11. The method as set forth in claim 9, wherein, alternatively, if the optimum speeds are known, the number and/or combination of the fans from among the k fans is determined in order to operate at an optimized operating point.
